(19) United States
(12) Patent Application Publication
(10) Pub. No.: US 2023/0249110 A1
(43) Pub. Date: Aug. 10, 2023

(54) BIODEGRADABLE CARTRIDGE OF A WATER FILTER

(71) Applicant: Zhuangyong Chen, Cumming, CA (US)

(72) Inventor: Zhuangyong Chen, Cumming, CA (US)

(21) Appl. No.: 17/877,292

(22) Filed: Jul. 29, 2022

Related U.S. Application Data
(60) Provisional application No. 63/308,046, filed on Feb. 8, 2022.

(51) Int. Cl. B01D 35/31; C08L 33/02; C08L 67/02; B01D 39/16

(52) U.S. Cl. CPC B01D 35/31; C08L 33/02; C08L 67/02; B01D 39/16; C08L 2201/06; B01D 2201/293

(57) ABSTRACT

A completely biodegradable cartridge for a water filter that can replace traditional non-biodegradable cartridges. The cartridge may also include one or two caps also made from biodegradable material.

### CROSS-REFERENCE TO RELATED APPLICATIONS

This application claims priority from a U.S. Provisional Patent App. No. 63/308,046 filed on Feb. 8, 2022, which is incorporated herein by reference in its entirety.

### FIELD OF INVENTION

The present invention relates to water filters, and more particularly, the present invention relates to a biodegradable cartridge.

### BACKGROUND

The water collected from environmental sources is filtered before use to remove the contaminants, such as sand. Water is passed through a porous filter medium through which water can pass but contaminants are trapped. The efficiency of the water filters declines over time and must be replaced with a new one. The U.S. water filter market size keeps growing rapidly and has reached USD 5.59 billion in 2020. However, the disposal of wastewater filters has created an environmental hazard. The known water filters are usually made with non-biodegradable plastic or other non-biodegradable materials. The non-biodegradable plastic filters have a costly replacement and are not environmentally friendly.

Thus, considering the increasing domestic and industrial use of water filters, a need is appreciated for novel water filters that are devoid of the aforesaid drawbacks of the known water filter systems.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to biodegradable water filters.

It is another object of the present invention that the materials for water filters are sustainable and environmental-friendly.

It is still another object of the present invention to reduce methane emissions and to return the organic carbon back to the soil and aquatic ecosystems.

It is a further object of the present invention to facilitate environment-friendly marketing strategies.

It is yet another object of the present invention that the water filters can retrofit to conventional water filter systems.

It is a further object of the present invention that the efficiency and durability of water filters match or exceed that of conventional water filters.

It is still a further object of the present invention that water filters have a long shelf life.

It is an additional object of the present invention that the water filters can be easily recycled or safely disposed of in a landfill.

In one aspect, disclosed is a water filter that includes a cartridge made from biodegradable material. The cartridge can include one or more caps also made from biodegradable material. The caps can be separate from the cartridge body or integral to form a single unit. The biodegradable material is selected from polylactic acid, polyhydroxyalkanoate, and the like materials.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 shows a cartridge, according to an exemplary embodiment of the present invention.

FIG. 2 shows another embodiment of the cartridge, according to the present invention; FIG. 2a is a cross-sectional view of the cartridge taken along line 8-8.

FIG. 3 is an exploded view of the cartridge, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be outlined in order to provide a thorough understanding of the subject innovation. It may be evident, however, that the claimed subject matter may be practiced without these specific details. In other instances, well-known structures and apparatus are shown in block diagram form to facilitate describing the subject innovation. Moreover, the drawings may not be to scale.

Disclosed is a cartridge for water filter systems that can be made of biodegradable materials. The disclosed cartridge can be completely made of biodegradable materials including the caps if any. The disclosed cartridge can be safely disposed of and gets quickly degraded in a landfill to become part of the soil. No harmful chemicals are left behind after the degradation of the cartridge. The disclosed cartridge can have the same efficiency and strength as the conventional non-biodegradable cartridge but are environmentally friendly. The disclosed cartridge can easily be retrofitted into a conventional or standard water filter system replacing the old non-biodegradable cartridges. The disclosed cartridge can be used in both the commercial and residential filter housings.

In one implementation, the biodegradable polymers (BDPs) or biodegradable plastics can be used, such as PLA and PHA. Depending on the origins, BDPs can be classified as being either bio-based or petrochemical-based. Starch may be used as a binder or glue to adhere solid constituents together to form a heterogeneous mixture of different components. It can also be mixed with polymers for better performance.

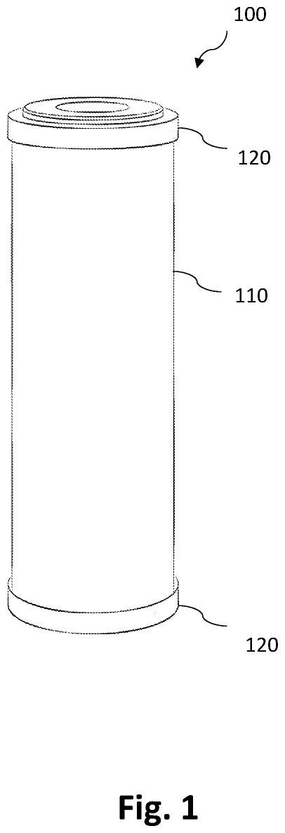

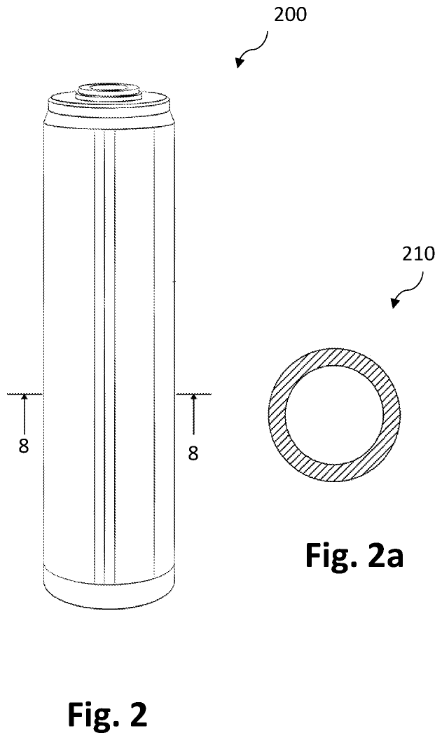

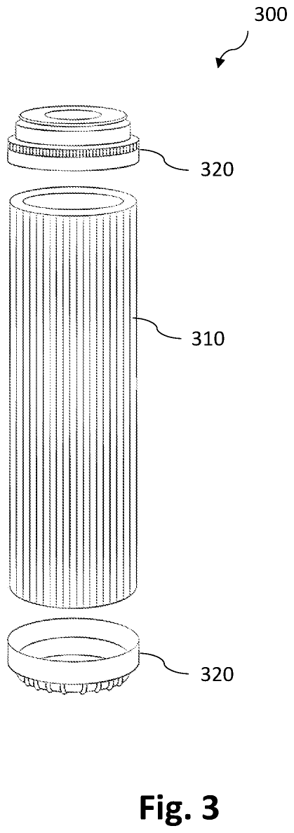

Referring to FIG. 1 shows the disclosed cartridge 100 that includes a cartridge body 110 and two caps 120 on both ends. The cartridge with the two caps can be made from biodegradable material. Refer to FIG. 2 which shows another embodiment of the cartridge 200 in which the caps are integral. A cross-section 210 of the cartridge 200 is shown in FIG. 2. FIG. 3 which is an exploded view of another embodiment of the cartridge 300 that includes a body 310 and two caps 320 at two ends of the body 310. The cartridge body 310 and the two caps 320 can be made from the biodegradable material.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A cartridge for a water filter comprises:
a body made from biodegradable material.

2. The cartridge according to claim 1, wherein the cartridge further comprises:
two caps, wherein the two caps are made from biodegradable material.

3. The cartridge according to claim 1, wherein the biodegradable material is polylactic acid.

4. The cartridge according to claim 1, wherein the biodegradable material is polyhydroxyalkanoate.
